(19) United States
(12) Patent Application Publication
(10) Pub. No.: US 2026/0307304 A1
(43) Pub. Date: Oct. 8, 2026

(54) VIBRATION ASSISTED OVERMOLDING OF A COMPONENT

(71) Applicant: Magna Exteriors Inc., Aurora (CA)

(72) Inventors: Alexis Baltazar y Jimenez, Troy, MI (US); Riad Chaaya, Clarkston, MI (US); Stanislav Tichy, Troy, MI (US); Joseph D. Fondessy, Northwood, OH (US); Mark J. Hess, Gaines, MI (US); Parvinder S. Walia, Shelby Township, MI (US)

(21) Appl. No.: 19/566,485

(22) Filed: Mar. 13, 2026

Related U.S. Application Data
(60) Provisional application No. 63/783,789, filed on Apr. 4, 2025.

(51) Int. Cl. B29C 45/00; B29C 45/14; B29K 75/00; B29K 105/00

(52) U.S. Cl. CPC B29C 45/0025; B29C 45/0001; B29C 45/14819; B29K 2075/00; B29K 2105/0032; B29K 2995/0026; B29K 2995/0037

(57) ABSTRACT

A method for forming an overmolded component may include providing a substrate, an overmold cavity, and one or more agitators capable of inducing vibration at or within the overmold cavity, wherein the overmold cavity is at least partially defined by the substrate. Material may then be provided to form an overmolded layer in the overmold cavity and the one or more agitators may be activated to induce vibration in the material.

### REFERENCE TO RELATED APPLICATIONS

This application claims the benefit of U.S. Provisional Application Serial No. 63/783,789 filed on Apr. 4, 2025 the content of which is incorporated herein by reference in its entirety.

### FIELD

The present disclosure relates to a component with an overmolded surface and methods of making the component with the overmolded surface.

### BACKGROUND

In injection molding, air bubbles and poorly distributed additives in polyurethane over-molded articles can lead to defects such as structural weaknesses, inconsistent material properties, and undesirable surface defects. During the molding process, air may become trapped between the polyurethane material and the substrate, within the polyurethane material, or against features of the overmold cavity, preventing complete and uniform overmolding. These trapped air pockets can result in voids, reduced bond strength, localized stress concentrations, and cosmetic imperfections. Existing tooling and mold design techniques for filling and venting polyurethane over-molded articles are often inadequate to fully evacuate air from the overmold cavity. As a result, achieving consistent part quality and structural integrity remains a challenge using current polyurethane over-molding processes.

### SUMMARY

In at least some implementations, a method for forming an overmolded component, includes providing a substrate, an overmold cavity, and one or more agitators capable of inducing vibration at or within the overmold cavity, wherein the overmold cavity is at least partially defined by the substrate, providing material to form an overmolded layer into the overmold cavity, and activating the one or more agitators to induce vibration in the material.

In at least some implementations, the one or more agitators includes a mechanical vibrator, an ultrasonic transducer, or a piezoelectric actuator.

In at least some implementations, the material is a polyurethane with a viscosity of between 50 mPa·s and 150 mPa·s.

In at least some implementations, the material is a clear polyol with a viscosity between 3,000-13,500 mPas at 23°C and between 50-150mPas at 80°C.

In at least some implementations, the material is a colored polyol with a viscosity between 400-15,000mPas at 80°C.

In at least some implementations, wherein the material is a polyurethane with a pigment particle size between 0.2-5 micron.

In at least some implementations, the one or more agitators induce vibration at or within the overmold cavity at a frequency of between 10 Hz and 200 Hz.

In at least some implementations, the vibration has an amplitude that is less than 1.0 mm.

In at least some implementations, the vibration has an amplitude that is less than 0.6 mm.

In at least some implementations, at least one of the one or more agitators forms at least part of the overmold cavity or contacts the material.

In at least some implementations, at least one of the one or more agitators contacts the substrate.

In at least some implementations, at least one of the one or more agitators is positioned on or in a mix head from which material is provided into the overmold cavity.

In at least some implementations, at least one of the one or more agitators is positioned on an exterior of mold tooling that defines the overmold cavity.

In at least some implementations, the one or more agitators are intermittently activated and stopped.

In at least some implementations, a frequency or amplitude of the vibration of the one or more agitators is varied over time.

In at least some implementations, the vibration induced in the material is at a frequency or amplitude configured based at least in part on one or more of a material type, a shape of the overmold cavity, or a shape of the substrate, and the frequency or amplitude of the vibration is achieved by adjusting an output of the one or more agitators.

In at least some implementations, a method for forming an overmolded component, includes providing a substrate, an overmold cavity, and one or more agitators capable of inducing vibration at or within the overmold cavity, wherein the overmold cavity is at least partially defined by the substrate and the one or more agitators includes one or more of a mechanical vibrator, an ultrasonic transducer, and a piezoelectric actuator, providing material to form an overmolded layer into the overmold cavity, and activating the one or more agitators to induce vibration in the material.

In at least some implementations, the vibration induced in the material is at a frequency or amplitude configured based at least in part on one or more of a material type, a shape of the overmold cavity, or a shape of the substrate, and the frequency or amplitude of the vibration is achieved by adjusting an output of the one or more agitators.

In at least some implementations, at least one of the one or more agitators form at least part of the overmold cavity or contacts the material.

In at least some implementations, at least one of the one or more agitators contacts the substrate.

In at least some implementations, at least one of the one or more agitators is positioned on or in a mix head from which material is provided into the overmold cavity or on an exterior of a tool that houses the overmold cavity.

In at least some implementations, a system for overmolding a component includes a first mold part and a second mold part arranged to receive a substrate, an overmold cavity defined at least partially by one or both of the first mold part and the second mold part, an injection passage in fluid communication with the overmold cavity, a mix head configured to provide material into the injection passage, and one or more agitators capable of inducing vibration at or within the overmold cavity, wherein the overmold cavity is at least partially defined by the substrate and the one or more agitators includes one or more of a mechanical vibrator, an ultrasonic transducer, and a piezoelectric actuator.

In at least some implementations, at least one of the one or more agitators form at least part of the overmold cavity or contacts the material.

In at least some implementations, at least one of the one or more agitators contacts the substrate.

In at least some implementations, at least one of the one or more agitators is positioned on or in a mix head from which material is provided into the overmold cavity.

In at least some implementations, at least one of the one or more agitators is positioned on an exterior of a tool that houses the overmold cavity.

### BRIEF DESCRIPTION OF THE DRAWINGS

FIG. 1 is a schematic view of a molding system including one or more agitators used in overmolding a component;

FIG. 2 is a perspective view of the molding system including mold tooling that defines an overmold cavity;

FIG. 3 is a cross-sectional view of the mold tooling, an agitator positioned within or as part of the overmold cavity;

FIG. 4 is a cross-sectional view of the mold tooling, an agitator positioned against a substrate that defines part of the overmold cavity;

FIG. 5 is a cross-sectional view of the mold tooling with an agitator positioned in a mix head;

FIG. 6 is a cross-sectional view of the mold tooling with an agitator positioned on an exterior of the tooling;

FIG. 7 is a cross-sectional view of the tool with agitators positioned within one or more mold parts of the mold tooling; and

FIG. 8 is a flowchart of a method of forming an overmolded component.

### DETAILED DESCRIPTION

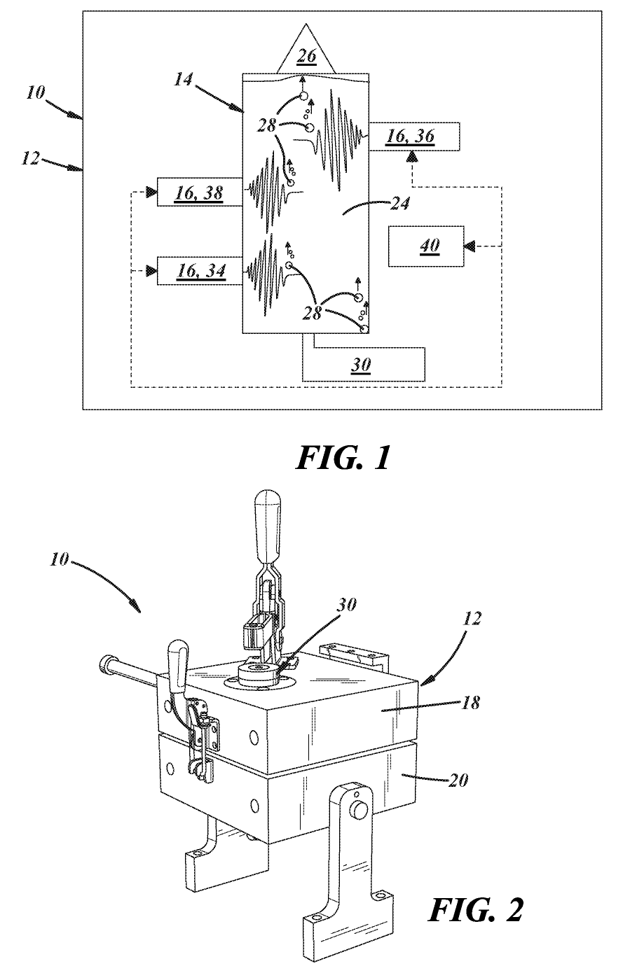

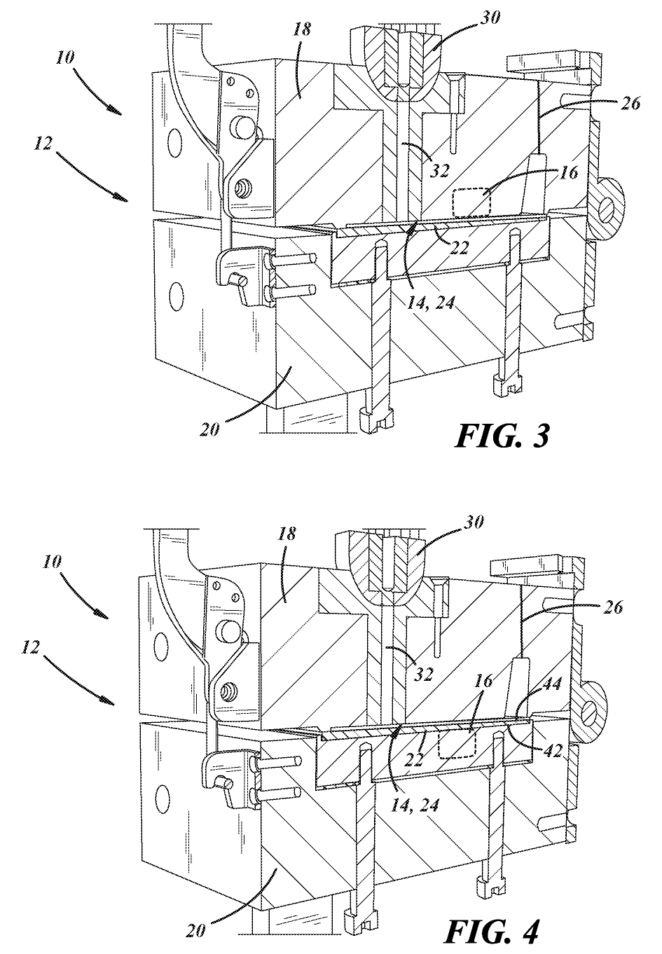

Referring in more detail to the drawings, FIGS. 1-7 show a mold system 10 for overmolding part or all of a component. The mold system 10 includes mold tooling 12 that defines an overmold cavity 14, and one or more agitators 16 configured to induce vibration at or within the overmold cavity 14. The mold tooling 12 includes multiple more parts and in the embodiments shown in FIGS. 2-7, a first mold part 18 and a second mold part 20 collectively define at least part of the overmold cavity 14. The overmold cavity 14 is defined in part by a substrate 22 (see FIGS. 3-7) and material 24 is injected into the overmold cavity 14 to form an overmolded layer on the substrate 22. In at least some implementations, the one or more mold parts 18, 20 include one or more vents 26 that are in fluid communication with the overmold cavity 14 to vent gas (e.g. air) bubbles 28 expelled from the overmold cavity 14. In at least some implementations, the overmolded layer is formed from a low-viscosity material, such as polyurethane (PUR), and defines an exterior surface of a vehicle component including the substrate 22, which may include a class A surface or show surface visible when the component is installed on a vehicle.

In at least some implementations, the mold tooling includes a mix head 30 configured to receive and combine material components prior to injection into the overmold cavity 14. The mix head 30, shown schematically in FIG. 1 and on the tooling 12 in FIGS. 2–7, receives a base material and any selected additives and blends them under controlled pressure and flow conditions to produce a mixture. After blending, the mixed material 24 is directed through an injection passage 32 and into the overmold cavity 14.

In at least some implementations, one or more additives may be introduced into the base material prior to or during injection. Such additives may be used to produce a clear, tinted, or colored material, or to impart visual or functional characteristics such as metallic flakes, pearlescent particles, or other decorative or performance-related properties. The additives may be selectively controlled to achieve a desired appearance, optical property, or surface effect in the overmolded layer. In at least some implementations, a clear material, such as clear polyol, may have a viscosity between 3,000 and 13,500 mPa·s at 23°C, and may decrease to between 50 and 150 mPa·s at 80°C. The viscosity for a colored polyol may be between 400 and 15,000 mPa·s at 80°C. In at least some implementations, pigments added to the material may have particle sizes between 0.2 microns and 5 microns, and in other implementations up to 50 microns. This configuration allows additives, including clear, tinted, colored, or metal-flake ingredients, to be incorporated at the mix head 30 and carried into the overmold cavity 14 through the injection passage 32 positioned within the mold tooling 12 during the injection process.

As shown in FIG. 1, the one or more agitators 16 may include one or more of a mechanical vibrator 34, an ultrasonic transducer 36, and/or a piezoelectric actuator 38, and the agitator(s) 16 may be positioned on or in the tooling 12, or both. For example, the mechanical vibrator 34 may include an electric powered motor configured to rotate an off-center weight, generating vibrations. The ultrasonic transducer 36 may operate by converting electrical energy into sound waves. The piezoelectric actuator 38 could utilize the deformation of piezoelectric crystals when an electric field is applied to produce vibrations. These different types of agitators 16 can be used independently or in combination depending on the specific requirements of the application.

A controller 40 may be in electrical communication to control the frequency and amplitude of the vibrations produced by the agitator(s) 16 and therefore the frequency and amplitude of vibrations induced in the overmold cavity 14 and material 24. The frequency and amplitude of vibrations produced by each agitator 16 can be controlled in various ways. In the example of the mechanical vibrator 34, frequency may be controlled by adjusting the motor’s rotational speed, while amplitude may be governed by varying the design of the off-center weight. For example, the mass of the weight and the distance the mass is off-center by may be adjusted to achieve a desired amplitude of vibration. For the ultrasonic transducer 36, the controller 40 may have a signal generation circuit that can output a controlled alternating current signal at a specified frequency. The controller 40 may adjust the intensity of the signal, which directly influences the amplitude of the vibrations produced by the ultrasonic transducer 36. When an electric field is applied to piezoelectric crystals of the piezoelectric actuator 38, the crystals expand or contract, which generates vibrations. The piezoelectric actuator 38 may be powered by an alternating current output by the controller at a specified frequency and the controller 40 may adjust the frequency of the alternating current to adjust the frequency of vibration emitted. The amplitude of the vibrations may be controlled by varying the voltage applied to the piezoelectric actuator 38. By increasing the applied voltage, the electric field becomes stronger, leading to a larger deformation of the crystals, which results in higher amplitude vibrations. Conversely, reducing the voltage results in smaller deformations and thus weaker vibrations.

The controller 40 may include, but not be limited to, a processor(s), computer(s), DSP(s), memory, storage, register(s), timing, interrupt(s), communication interface(s), and input/output signal interfaces, and the like, as well as combinations comprising at least one of the foregoing. As used herein the terms controller 40n may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions/programs executable by a processor or controller or the like to enable control or allocate resources of a computing device.

In at least some implementations, at least one of the one or more agitators 16 forms at least part of the overmold cavity 14 or is received in the overmold cavity 14 and arranged to contact the material when injected into the overmold cavity 14. As shown in FIG. 3, an agitator 16 is included in or carried by first mold part 18 so that part of the agitator 16 is in or defines a surface of the overmold cavity 14. In this way, when material fills the overmold cavity 14, the agitator 16 is in contact with the material to induce vibrations into the material 24 within the overmold cavity 14, and possibly also in the injection passage 32, and/or the mix head 30. One or more agitators 16 may be positioned as desired along the overmold cavity 14.

In at least some implementations, at least one of the one or more agitators 16 contacts the substrate 22 that receives the overmolded layer. As shown in FIG. 4, an agitator 16 is included in the second mold part 20 and contacts an underside 42 or B-side of the substrate 22. The underside 42 or B-side of the substrate 22 is opposite to an A-side 44 or the side configured to receive the material forming the overmolded layer. In this way, the agitator 16 can induce vibration within the overmold cavity 14, the injection passage 32, and/or the mix head 30 by vibrating the substrate 22 which in turn propagates vibration in the overmold cavity 14 and possibly in other parts of the mold tooling 12. One or more agitators 16 may be positioned as desired along the substrate 22.

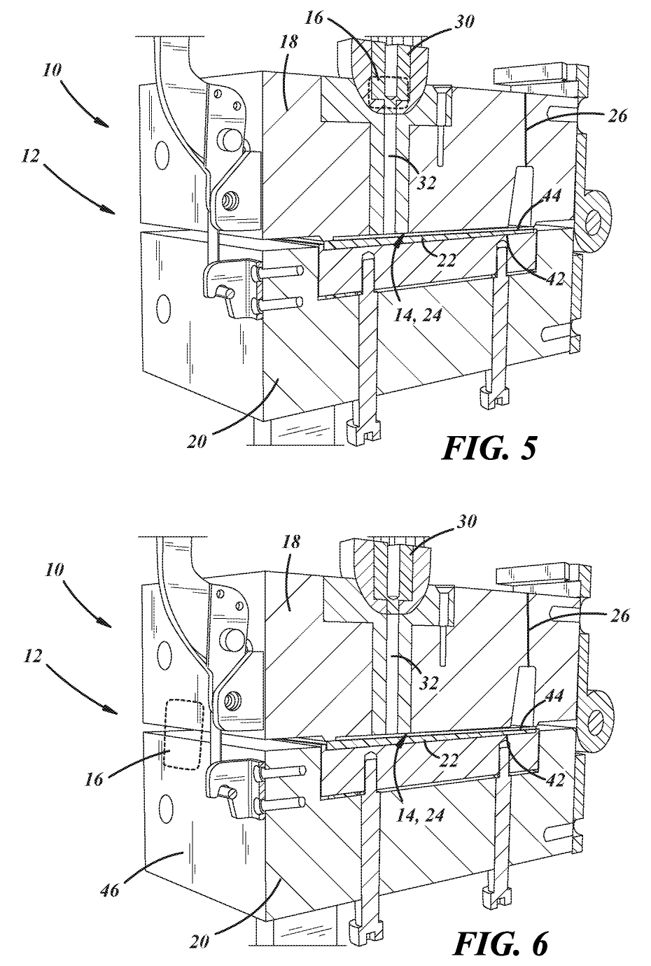

In at least some implementations, at least one of the one or more agitators 16 is positioned within or on the mix head 30, or otherwise arranged to induce vibrations in the mix head 30 itself or in material 24 within the mix head 30. As shown in FIG. 5, an agitator 16 is included in or on the mix head 30. In this way, the agitator 16 can vibrate the mix head 30 and material 24 within the mix head 30. In at least some implementations, vibrations from the mix head 30 may induce vibration within the overmold cavity 14, the injection passage 32, and/or the mix head 30. One or more agitators 16 may be positioned as desired in or on the mix head 30, to vibrate the mix head 30 and/or material 24 within or flowing through the mix head 30.

In at least some implementations, at least one of the one or more agitators 16 is positioned on the exterior 46 of the mold tooling 12, such as on one or both of the first mold part 18 and the second mold part 20. As shown in FIG. 6, an agitator 16 is included on the exterior 46 of the mold tooling 12 and contacts the outer surface of both the first mold part 18 and the second mold part 20. In this way, the agitator 16 may vibrate the mold parts 18, 20 which induces vibration within the material 24 in the overmold cavity 14, the injection passage 32, and/or the mix head 30. One or more agitators 16 may be positioned as desired along the exterior 46 of the mold tooling 12.

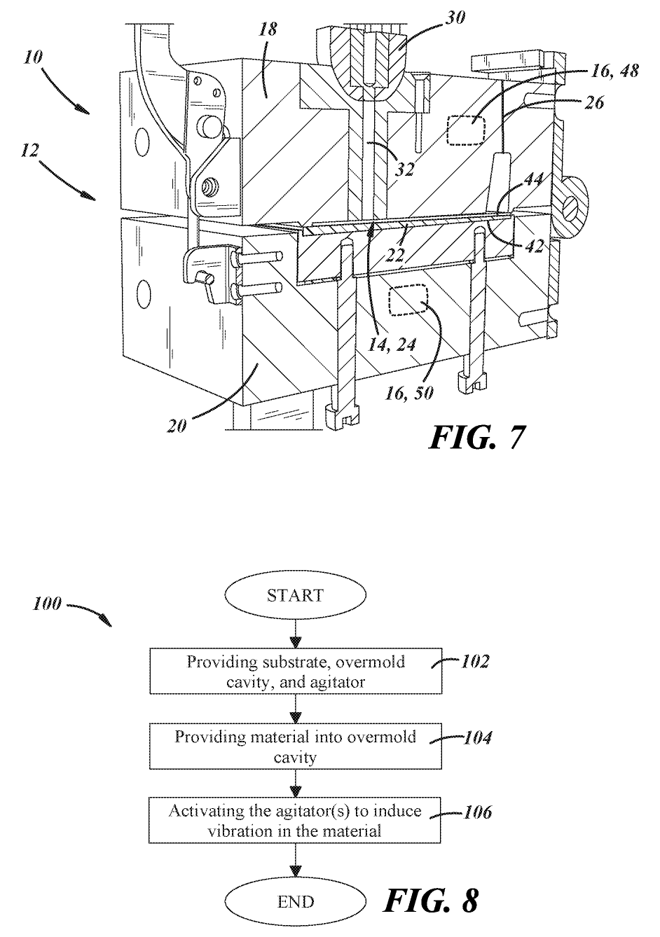

In at least some implementations, at least one of the one or more agitators 16 is positioned within one or more mold parts 18, 20 of the mold tooling 12, between the exterior 46 and the overmold cavity 14. As shown in FIG. 7, a first agitator 48 is included within the first mold part 18 of the mold tooling 12 and a second agitator 50 is included within the second mold part 20 of the mold tooling 12. In this way, the agitators 48, 50 may vibrate the mold parts 18, 20 which induces vibration within the material 24 within the overmold cavity 14, the injection passage 32, and/or the mix head 30. One or more agitators 16 may be positioned as desired within the mold parts 18, 20 of the mold tooling 12.

In injection molding, air trapped in polyurethane over-molded articles can lead to defects such as structural weaknesses, inconsistent material properties, and undesirable surface defects. During the molding process, air may become trapped between the polyurethane material and the substrate, within the polyurethane material, or against features of the overmold cavity, preventing complete and uniform overmolding. These trapped air pockets can result in voids, reduced bond strength, localized stress concentrations, and cosmetic imperfections. Existing tooling and mold design techniques for filling and venting polyurethane over-molded articles are often inadequate to fully evacuate air from the overmold cavity. As a result, achieving consistent part quality and structural integrity remains a challenge using current polyurethane over-molding processes. Therefore, as shown in FIG. 8, a method 100 for forming an overmolded component is provided herein.

The method 100 may include, in step 102, providing a substrate 22, an overmold cavity 14, and one or more agitators 16 capable of inducing vibration at or within the overmold cavity 14. In at least some implementations the overmold cavity 14 is at least partially defined by the substrate 22. As disclosed herein, in at least some implementations, the substrate 22 may be positioned between a first mold part 18 and a second mold part 20 of the mold tooling 12, so that in combination with one or both of the first and second mold parts 18, 20, the substrate 22 defines at least part of the overmold cavity 14 configured to receive material 24 to form the overmolded component.

Step 104 may include providing material 24 into the overmold cavity 14 to form an overmolded layer. As disclosed herein, the material 24 may be added to the mix head 30 where any additives may be mixed into the material 24. From the mix head 30, the material 24 may flow into the injection passage 32 and into the overmold cavity 14. The material 24 is injected onto the A-side 44 of the substrate 22 and fills the overmold cavity 14.

Step 106 may include activating the one or more agitators 16 to induce vibration in the material 24. The agitators 16 may be activated while the material 24 is in the mix head 30, or in the injection passage 32 or in the overmold cavity 14, or any combination including all of these. The agitators 16 may be operated continuously or intermittently. In at least some implementations, step 106 includes intermittently activating and stopping the one or more actuators 16. For example, intermittent activation and stoppage of the actuator(s) 16 may be desired while mixing the material 24 in the mix head 30, while the material 24 flows into the overmold cavity 14 via the injection passage 32, or after the material 24 enters the cavity 14 for at least a portion of the curing process. This intermittent activation may be used to periodically remove gas bubbles and other surface defects from the material 24. Intermittent activation of the agitator(s) 16 offers several processing benefits, including improved venting of entrapped gases, enhanced flow uniformity and additive dispersion for better appearance (remove trapped bubbles, eliminate “crows’ foot”, improve metallic-pigment distribution), reduced thermal and mechanical loading on both the substrate and tooling, and more precise control of shear conditions within the material 24. By pulsing the vibration rather than applying it continuously, the process helps stabilize the flow front, minimize turbulence-related defects, prevent pigment or flake settling, and reduce unnecessary substrate deflection or tool wear. At the same time, it maintains effective bubble removal throughout filling and enables each section of the tool to be tuned to specific vibration frequencies and displacements to accelerate curing and reduce demolding force. In at least some implementations, one or both of the frequency and amplitude of vibration by the actuator(s) 16 may be varied over time.

The agitators 16 may be activated and controlled by the controller 40 to achieve frequencies and amplitudes to prevent the formation of defects in the component caused by air/gas trapped within the material 24 or between the material 24 and the overmold cavity 14 or by poor distribution of additives throughout the material 24. For example, in at least some implementations, the following ranges of frequencies and amplitudes of vibration may be desirable for preventing and removing defects from the material 24. For removing gas bubbles, a low frequency vibration such as from 10 to 60 Hz may be desired. In at least some implementations, the frequency for degassing the material 24 may increase up to 200 Hz. To prevent aeration, which is gas bubbles within the material 24 that are too small to vent from the material naturally, the agitator(s) 16 may be controlled by the controller 40 to induce a vibration within the material 24 with a frequency from 20 to 40 Hz with an amplitude from 0.2 to 0.3 mm. To prevent the “Crow’s Foot” defect, the agitator(s) 16 may be controlled by the controller 40 to induce a vibration within the material 24 with a frequency from 20 to 50 Hz with an amplitude from 0.2 to 0.5 mm. To improve pigment distribution and metallic-flake distribution the agitator(s)16 may be controlled by the controller 40 to induce a vibration within the material 24 with a frequency from 10 to 30 Hz with an amplitude less than or equal to 0.3 mm. To accelerate the curing of the material 24 within the overmold cavity 14, including materials with additives such as metallic flakes, the agitator(s) may be controlled by the controller 40 to induce a vibration within the material 24 with a frequency from 30 to 50 Hz with a low amplitude that in at least some implementations is less than or equal to 0.1 mm. To reduce the demolding force required to remove the overmolded component from the overmold cavity 14, the agitator(s) 16 may be controlled by the controller 40 to induce a vibration within the material 24 with a frequency from 80 to 200 Hz with an amplitude of less than or equal to 0.1 mm. In at least some implementations the agitator(s) 16 may be controlled by the controller 40 to induce vibration within the material 24 with an amplitude of 1.0 mm or less. In at least some implementations the agitator(s) 16 may be controlled by the controller 40 to induce vibration within the material 24 with an amplitude of 0.6 mm or less.

Therefore, the method 100 enables the removal of air and gasses from the molding material to enable a cleaner, higher quality overmold and finished product. It can also reduce defects, such as the "crow's foot" defect, which is small, radiating, surface-level cracks or stresses often caused by excessive pressure and inconsistency within the molded material. Additionally, the method 100 helps minimize the formation of pronounced seams, which are typically seen when the overmold cavity is defined by multiple parts, leading to a smoother and more uniform surface. Another potential benefit is the improved distribution of additives, such as pigments and metallic flakes, throughout the material, due to improved mixing of materials that may result from vibrations in the materials. This ensures a more consistent appearance and improved performance. Further, the method 100 accelerates curing times, which not only speeds up production but also reduces the force required during demolding. This reduction in demolding force leads to less wear on the mold over time, increasing the lifespan of the tooling.

The forms of the innovations herein disclosed constitute presently preferred embodiments and many other forms and embodiments are possible. It is not intended herein to mention all the possible equivalent forms or ramifications of the innovations. It is understood that the terms used herein are merely descriptive, rather than limiting, and that various changes may be made without departing from the spirit or scope of the present disclosure.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A method for forming an overmolded component, comprising:
providing a substrate, an overmold cavity, and one or more agitators capable of inducing vibration at or within the overmold cavity, wherein the overmold cavity is at least partially defined by the substrate;
providing material to form an overmolded layer into the overmold cavity; and
activating the one or more agitators to induce vibration in the material.

2. The method of claim 1, wherein the one or more agitators includes a mechanical vibrator, an ultrasonic transducer, or a piezoelectric actuator.

3. The method of claim 1, wherein the material is a polyurethane with a viscosity of between 50 mPa·s and 150 mPa·s.

4. The method of claim 1, wherein the material is a clear polyol with a viscosity between 3,000-13,500 mPas at 23°C and between 50-150mPas at 80°C.

5. The method of claim 1, wherein the material is a colored polyol with a viscosity between 400-15,000mPas at 80°C.

6. The method of claim 1, wherein the material is a polyurethane with a pigment particle size between 0.2-5 micron.

7. The method of claim 1, wherein the one or more agitators induce vibration at or within the overmold cavity at a frequency of between 10 Hz and 200 Hz.

8. The method of claim 1, wherein the vibration has an amplitude less than 1.0 mm.

9. The method of claim 1, wherein the vibration has an amplitude less than 0.6 mm.

10. The method of claim 1, wherein at least one of the one or more agitators forms at least part of the overmold cavity or contacts the material.

11. The method of claim 1, wherein at least one of the one or more agitators contacts the substrate.

12. The method of claim 1, wherein at least one of the one or more agitators is positioned on or in a mix head from which material is provided into the overmold cavity.

13. The method of claim 1, wherein at least one of the one or more agitators is positioned on an exterior of mold tooling that defines the overmold cavity.

14. The method of claim 1, wherein the one or more agitators are intermittently activated and stopped.

15. The method of claim 1, wherein a frequency or amplitude of the vibration of the one or more agitators is varied over time.

16. The method of claim 1, wherein the vibration induced in the material is at a frequency or amplitude configured based at least in part on one or more of a material type, a shape of the overmold cavity, or a shape of the substrate, and the frequency or amplitude of the vibration is achieved by adjusting an output of the one or more agitators.

17. A method for forming an overmolded component, comprising:
providing a substrate, an overmold cavity, and one or more agitators capable of inducing vibration at or within the overmold cavity, wherein the overmold cavity is at least partially defined by the substrate and the one or more agitators includes one or more of a mechanical vibrator, an ultrasonic transducer, and a piezoelectric actuator;
providing material to form an overmolded layer into the overmold cavity; and
activating the one or more agitators to induce vibration in the material.

18. The method of claim 17, wherein the vibration induced in the material is at a frequency or amplitude configured based at least in part on one or more of a material type, a shape of the overmold cavity, or a shape of the substrate, and the frequency or amplitude of the vibration is achieved by adjusting an output of the one or more agitators.

19. The method of claim 17, wherein at least one of the one or more agitators form at least part of the overmold cavity or contacts the material.

20. The method of claim 17, wherein at least one of the one or more agitators contacts the substrate.

21. The method of claim 17, wherein at least one of the one or more agitators is positioned on or in a mix head from which material is provided into the overmold cavity or on an exterior of a tool that houses the overmold cavity.

22. A system for overmolding a component comprising:
a first mold part and a second mold part arranged to receive a substrate;
an overmold cavity defined at least partially by one or both of the first mold part and the second mold part;
an injection passage in fluid communication with the overmold cavity;
a mix head configured to provide material into the injection passage; and
one or more agitators capable of inducing vibration at or within the overmold cavity, wherein the overmold cavity is at least partially defined by the substrate and the one or more agitators includes one or more of a mechanical vibrator, an ultrasonic transducer, and a piezoelectric actuator.

23. The system of claim 22, wherein at least one of the one or more agitators form at least part of the overmold cavity or contacts the material.

24. The system of claim 22, wherein at least one of the one or more agitators contacts the substrate.

25. The system of claim 22, wherein at least one of the one or more agitators is positioned on or in a mix head from which material is provided into the overmold cavity.

26. The system of claim 22, wherein at least one of the one or more agitators is positioned on an exterior of a tool that houses the overmold cavity.
